(19) United States
(12) Patent Application Publication
(10) Pub. No.: US 2006/0294130 A1
(43) Pub. Date: Dec. 28, 2006

(54) Patent document content construction method

(76) Inventors: Von-Wun Soo, Hsinchu City (TW); Shih-Neng Lin, Kaohsiung City (TW); Shih-Yao Yang, Hsingchu (TW); Szu-Yin Lin, Hsingchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/250,459

(22) Filed: Oct. 17, 2005

(30) Foreign Application Priority Data
Jun. 24, 2005 (TW) 94121275

(51) Int. Cl. G06F 7/00

(52) U.S. Cl. 707/102

(57) ABSTRACT

A patent document content construction method is described. The method includes the following steps. A domain-specific thesaurus including a plurality of domain-specific terms is constructed. A semantic/syntactic annotation is performed for a claim of a patent to identify domain-specific terms, stop words, general terms, and punctuation. Defined regular expression sets are used to classify the words in a claim to build a structural relation of the claim. The defined expression sets include Common, Claim, Component, Reference, Attribute, Functionality, Contain, and Spatial. The structural relation includes the domain-specific terms, the general terms, and the triple relations of the domain-specific terms in the claim.

### RELATED APPLICATIONS

The present application is based on, and claims priority from, Taiwan Application Serial Number 94121275, filed Jun. 24, 2005, the disclosure of which is hereby incorporated by reference herein in its entirety.

### BACKGROUND OF THE INVENTION

1. Field of Invention

The invention relates to a word structure extraction method and, in particular, to a word structure extraction method for patent documents.

2. Related Art

Currently, one usually has to study and compare tens or even hundreds of prior patent documents to avoid infringements. Since patent documents are mainly described in terms of text, the comparison can only be done by human beings. This inevitably wastes a lot of manpower and lowers the efficiency. Therefore, it is highly desirable to provide a new method that can automatically extract the semantic structure of a patent document and perform similarity comparison.

### SUMMARY OF THE INVENTION

An objective of the invention is to provide a patent document content construction method that can automatically analyze and extract the structure of claims in a patent document.

Another objective of the invention is to provide a patent document content construction method that can integrate domain-specific terms and convert the domain-specific knowledge into a standardized database for sharing and reuse.

Yet another objective of the invention is to provide a patent document content construction method that helps extracting and indexing knowledge by providing more accurate domain-specific information.

In accord with the above-mentioned objectives, the invention provides a patent document content construction method. According to a preferred embodiment of the invention, the disclosed method includes the following steps. A domain-specific thesaurus comprising a plurality of domain-specific terms is built. The domain-specific terms form a hierarchical structure. A semantic/syntactic annotation is performed for a claim of a patent to identify the domain-specific terms, stop words, general terms, and punctuation. A structural relation is built upon the claim using the thesaurus. The structural relation includes the domain-specific terms, the general terms, and the triple relations of the domain-specific terms in the claim.

The invention has at least one or many of the following advantages associated with each embodiment. The disclosed patent document content construction method can automatically analyze and extract the structure in a claim of a patent document. The disclosed patent document content construction method can integrate domain-specific thesaurus and knowledge, and convert the domain-specific knowledge into a standardized database for sharing and reuse. The disclosed patent document content construction method can help extract and index knowledge by providing more accurate domain-specific information.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 shows the basic structure of chemical mechanical polishing;

FIG. 2 is a flow diagram of the disclosed patent document content construction method;

FIG. 3 shows an example of a claim maintenance tool;

FIG. 4A gives an example of the coding principles for the thesaurus;

FIG. 4B shows an example of the domain-specific thesaurus construction procedure;

FIG. 5 depicts an example of the thesaurus editing tool;

FIG. 6 shows the relation between a wafer and a polishing pad;

FIG. 7 shows the triple relation between the wafer and the polishing pad in FIG. 6;

FIG. 8 depicts an example of the semantic/syntactic annotation flowchart;

FIG. 9 depicts an exemplar parsing tree generated by JavaNLP;

FIG. 10 shows another example of the semantic/syntactic annotation flowchart;

FIG. 11 depicts the meta-character function of a regular expression;

FIG. 12 depicts eight types of regular expressions for extracting the semantic structure of claims;

FIG. 13A shows the regular expression of the Common type and its explanation;

FIG. 13B shows the regular expression of the Claim type;

FIG. 13C depicts some fixed ways of writing and a few examples of preambles.

FIG. 13D shows possible references for the component extraction;

FIG. 13E shows the execution order of the regular expressions in the Component type;

FIG. 13F shows the regular expression of component(x);

FIG. 13G gives an example of finding the components in U.S. Pat. No. 6,273,800.

FIG. 13H shows the execution order of the regular expressions in the Reference type;

FIG. 13I shows the regular expressions of the Reference type;

FIG. 13J depicts an example of finding components in U.S. Pat. No. 6,273,800;

FIG. 13K depicts a definition example of this regular expression;

FIG. 13L depicts a parameter example of CMP;

FIG. 13M shows the execution order of the regular expressions in the Attribute type;

FIG. 13N gives an example of the regular expression in the Attribute type;

FIG. 13O depicts the expression obtained from claim 19 of U.S. Pat. No. 6,454,634;

FIG. 13P depicts the execution order of the regular expressions in the Functionality type;

FIG. 13Q depicts an example of the regular expression in the Functionality type;

FIG. 13R depicts a schematic view of the polishing pad extracted from the regular expression.

FIG. 13S depicts the execution order or the regular expression in the Contain type;

FIG. 13T depicts an example of the regular expression in the Contain type;

FIG. 13U is a schematic view of the Contain relation;

FIG. 13V is a schematic view of the polishing pad extracted according to the regular expression;

FIG. 13W depicts the execution order of the regular expression of the Spatial type;

FIG. 13X depicts the regular expression of the Spatial relation;

FIG. 13Y is a schematic view of the Spatial relation;

FIG. 13Z is a schematic view of the polishing pad extracted according to the regular expression;

FIG. 14 depicts an example of the structure of the component in the claim;

FIG. 15 shows the first claim in U.S. Pat. No. 6,524,176;

FIG. 16 provides an example showing the structure of the plug and the hole of the claim shown in FIG. 15;

FIG. 17 shows the two layers of the polishing pad and an actual microscopic picture in comparison; and

FIG. 18 depicts a semantic graph of the claim.

### DETAILED DESCRIPTION OF THE PREFERRED EMBODIMENTS

The present invention will be apparent from the following detailed description, which proceeds with reference to the accompanying drawings, wherein the same references relate to the same elements.

The invention provides a new patent document content extraction system. This system can automatically analyze the semantic structure of a patent document and extract it. Subsequently, the semantic structure of the patent document is displayed via a graphic interface. The primary aspect of the invention is to convert a patent document into a machine-readable semantic structure based upon domain-specific knowledge.

Since a claim defines the scope of a patent and the largest privilege of the invention, it is most valuable to deeply understand the content of each claim. In order to facilitate a computer to automatically parse the semantic content of the claim and let people quickly understand its contents, there are at least four problems to overcome. (1) It is necessary to understand the domain-specific terms described in the patent. (2) It is necessary to understand the legal terms and drafting rules in patent documents. (3) To facilitate computers to comprehend patent contents, it is necessary to convert claims into a machine-readable semantic structure. (4) To let people quickly understand patent contents, it is helpful to convert verbose claims into a graphic representation that is easier to comprehend.

In this specification, we propose several methods to overcome these difficulties. By establishing a domain-specific thesaurus, it is possible for a system to extract domain-specific terms and their meanings while parsing patent documents in a specific field. Through an annotation process, the system is able to obtain the semantic/syntactic information of each word in a claim. Therefore, the first problem mentioned above can be solved. The legal terms in the patents and writing rules in the claims were previously analyzed by human beings. The present invention obtains such information by analyses and inductions . The extracted rules are converted into a regular expression for extracting information and constructing a semantic structure. Thus, the invention can also solve the second and third problems mentioned above. Finally, the semantic structure is converted into graphics, solving the fourth problem.

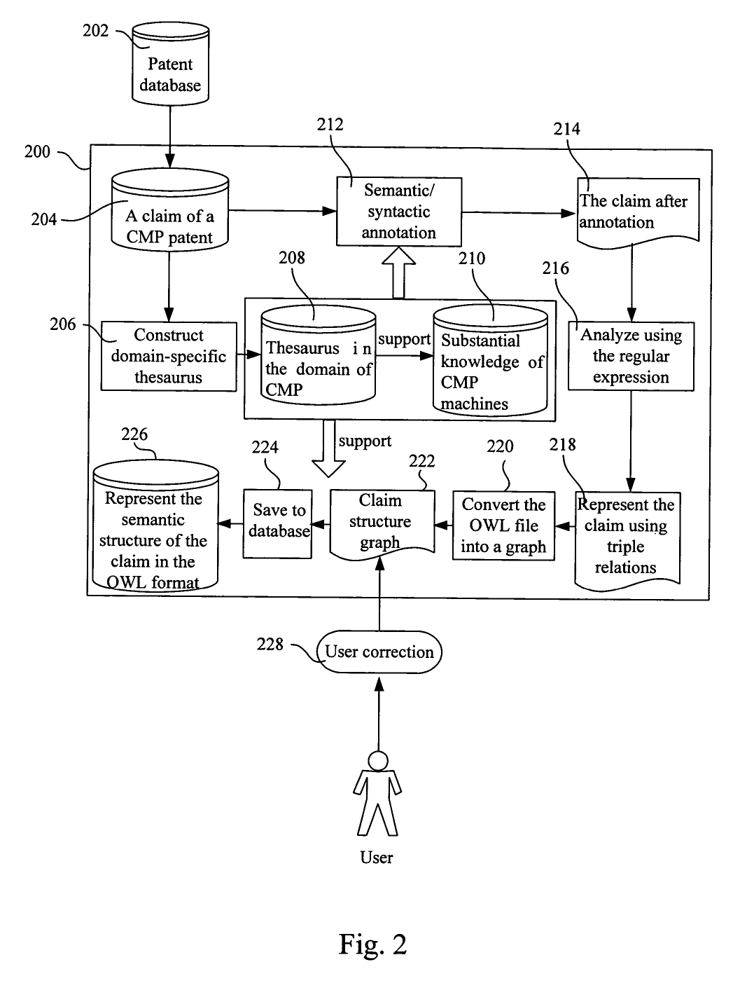

According to the flowchart of extracting the semantic structure of patent documents (FIG. 2), the patent document is retrieved from the United States Patent and Trademark Office (USPTO) (step 202) and saved to a database. Afterwards, a thesaurus editing tool is used (steps 204, 206) for experts to semi-automatically perform the thesaurus construction (step 208). The thesaurus is used to help comprehend the specific terms and semantic annotation in a patent document. It is also a reference for the similarity algorithm. Once the domain-specific thesaurus is established, the system can perform semantic/syntactic annotation (step 212). Since the content of the regular expression is constructed from legal terms and writing rules obtained and analyzed by human beings, the system uses the regular expression to extract semantic information in each patent document. After obtaining the semantic information, the system converts it into a semantic structure in the OWL format (step 218) and presents the semantic structure in a graphical way to the user (steps 220, 222). The user can correct any mistake in the currently extracted regular expression via a graphic interface (step 228). The corrected result is saved again in the OWL format into the database (step 224). This completes the extraction of patent document contents.

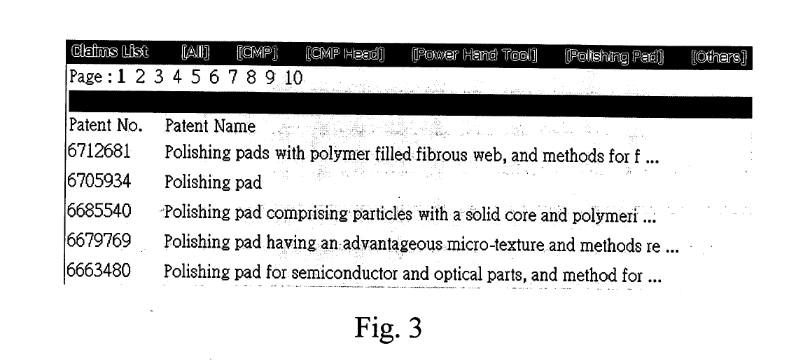

In this embodiment, we use a patent document in the field of chemical mechanical polishing as an example to explain the invention. FIG. 3 depicts an example of a claim maintenance tool. First, a patent document related to chemical mechanical polishing is selected from the patent data provided by the USPTO (step 202). Claims in the patent document are extracted using the claim maintenance tool (FIG. 3) and stored in the database (step 204).

We will describe the following contents:
1. Importance of and difficulties in extracting the semantic structure of a patent document.
2. Establishment of a domain-specific thesaurus.
3. Semantic/syntactic annotation of patent documents.
4. Extraction of the semantic structure using the regular expression.
5. Graphic presentation of the semantic structure of patent documents.

Importance of Computer Comprehensible Semantics

Most of the conventional methods for information retrieval stay at the stage of using keywords or phrases to label an article, instead of comprehending the semantic structure of the article. They only analyze the syntactic structure and perform similarity comparisons by statistics. However, using keywords has the following drawbacks:
1. It is difficult to achieve an accurate semantic expression.
2. It is possible to find irrelevant information.

If one wants to achieve a breakthrough of the existing information retrieval method, it is necessary for the computer to more accurately and deeply analyze the article contents and achieve semantic comprehension. To convert paragraphs without an explicit structure into structured information, one has to utilize the following techniques:
1. Establish a domain-specific thesaurus.
2. Perform semantic/syntactic annotation.
3. Use natural language processing techniques to identify the structure of an article.
4. Convert the extracted structured information into a machine-readable structure.

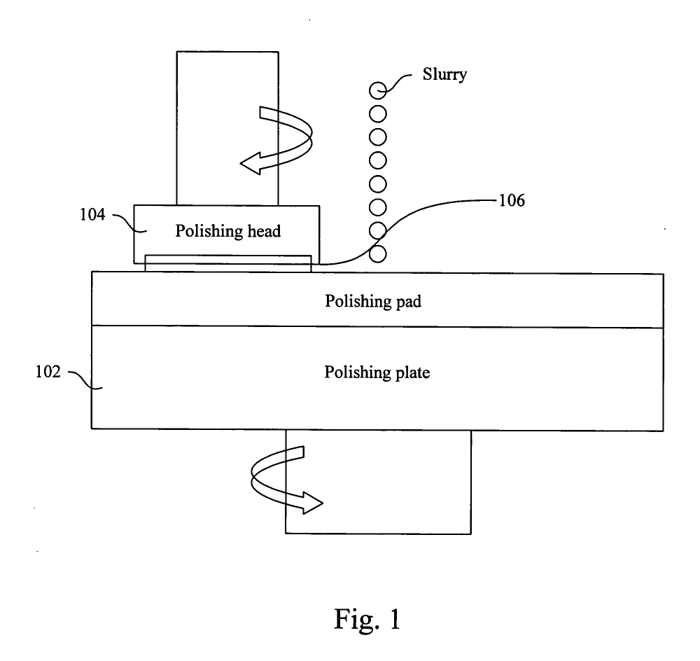

FIG. 1 shows a basic structure of chemical mechanical polishing (CMP). This specification takes one CMP patent as an embodiment. The chemical mechanical polishing is an overall planarization technique, using both chemical etching and mechanical polishing to remove protruding deposits. In addition to the rotation of a CMP platen 102, a CMP polishing head 104 also rotates concurrently, following a specific track to achieve an optimal polishing effect. Moreover, the polishing head 104 that holds a wafer 106 by using vacuum suction may deform the wafer 106. Therefore, the vacuum pressure also affects the flatness of polishing. Consequently, one needs to perform motion track control, rotating speed control, and vacuum pressure control for the CMP polishing head 104. According to the production, design, and classification principles in FIG. 1, computer-aided engineering (CAE) analyses and the functional definition obtained by patent analyses are used to determine the required actuator, control target, control strategy, and controller.

Contents of patent descriptions can generally be classified into two types:
1. Method: The patent contents are mainly statements of methods or flowcharts.
2. Structure: The patent contents are mainly statements of components and structures.

Characteristics of claims in a patent document include:
1. Unlike usual documents, sentences in claims are often very long.
2. There are independent and dependent claims; the scope of a dependent claim should be construed along with its independent claim.
3. Words having different meanings in law provide different protections, e.g. comprising and consisting of.

Thesaurus Construction

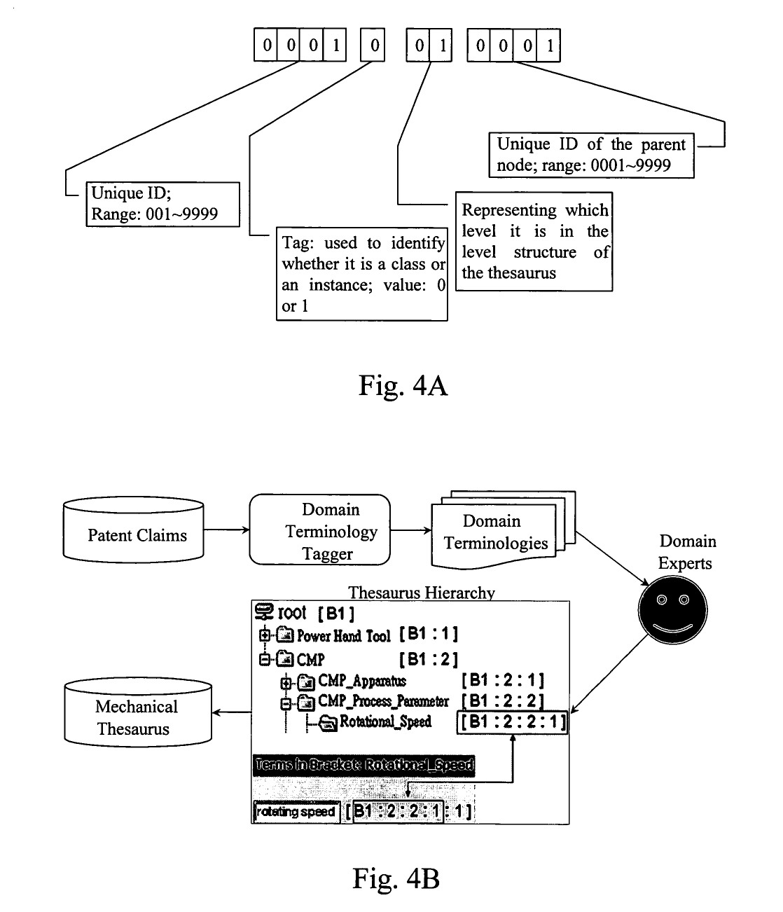

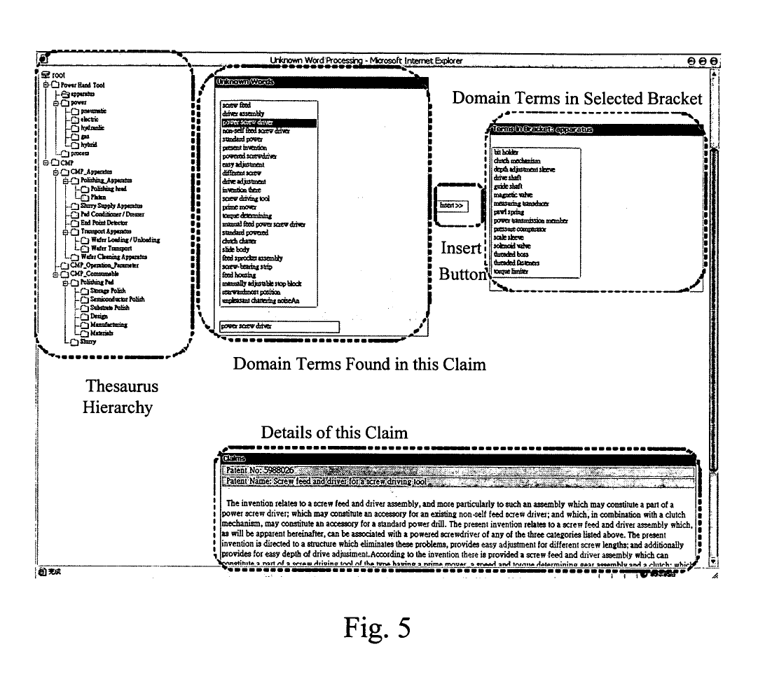

When describing domain-specific knowledge in a document, we often use domain-specific terms for specific concepts and for describing relations among the concepts in detail. Patent documents are such examples. FIG. 4A depicts an example of the coding principles of a domain-specific thesaurus. FIG. 4B depicts an example flowchart of constructing such a domain-specific thesaurus. FIG. 5 depicts an example of the editing tool for the domain-specific thesaurus. If we want to facilitate a computer to comprehend a patent document and achieve the machine-readable goal, the first task is to extract domain terminology in a specific domain using computers. With the help from experts of the domain (FIGS. 4A and 4B) and the editing tool for the domain-specific thesaurus (FIG. 5), the domain-specific terms are edited into the domain-specific thesaurus. Once the experts finish editing, one can obtain a domain-specific thesaurus with a hierarchical structure. In this hierarchical structure, each level and each word has a code that classifies domain-specific terms. Words at the same level and in the same group refer to the same type of objects. Therefore, machines can guess the meanings of words from the codes, thereby knowing which material, device or tool a specific word refers to.

For example, “rotating speed” should be maintained as a specific phrase in the domain of machines. Each of the words “rotating” and “speed” separately cannot accurately express the desired concept. As shown in FIG. 4B, the semantic code “rotating speed” in the thesaurus is “B1:2:2:1:1”, and that of “rotational speed” is “B1:2:2:1”. Therefore, the computer is able to determine that “rotating speed” is a specific concept under “rotational speed”.

The flowchart of constructing a domain-specific thesaurus is shown in FIG. 4B. First, possible domain-specific terms in the selected CMP patent claims are picked by a domain terminology finder. The domain terminology finder is comprised of some natural language processing rules designed by ourselves. By statistics, there are often one-word, two-word, . . . , five-word phrases in the claims of patents. Therefore, the picked terms are domain-specific terms, including multiword terms and singleton words. Afterwards, experts in the field single out the correct domain-specific terms from the system's list of suggested domain-specific terms and classify them into the level they belong. This completes the construction of the domain-specific thesaurus. From the above-mentioned construction procedure, we obtain a domain-specific thesaurus satisfying a certain standard (step 208).

The domain terminology finder relies on statistics. It is found from statistics that claims in patent documents often have one-word, two-word, . . . , five-word phrases as the domain-specific terms.

The coding principles of the domain-specific thesaurus include:
Need to have UID's (root UID=000).
Need to know whether it is a concept or an instance.
Need to know the depth of a node in the thesaurus.
Need to know the parent node.
Coding method: (001→999)(011)(00-99)(001→999).

The domain-specific thesauruses currently owned by the system:

There are three domain-specific thesauruses currently in the system of the invention. One is the machine device thesaurus, collecting terms of machines and devices in the field of CMP. Another is the unit thesaurus, collecting the unit terms in the field of CMP. The other is the attribute thesaurus, collecting the parameter terms in the field of CMP.

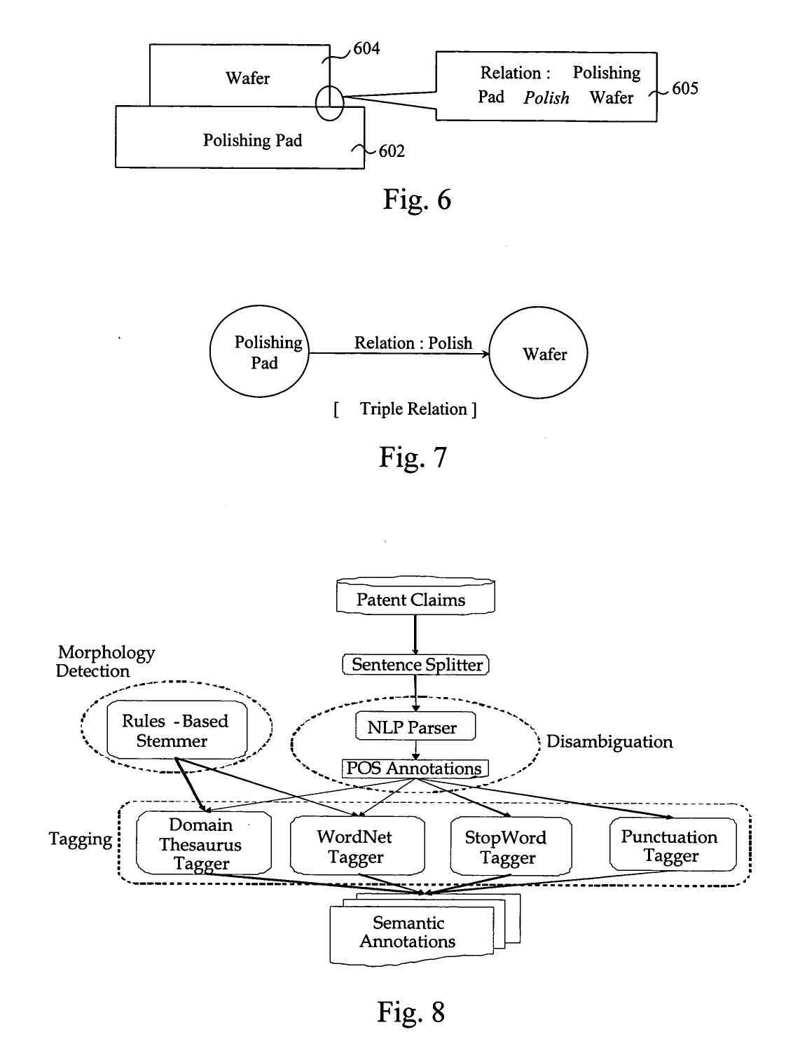

FIG. 6 depicts the relation between a wafer and a polishing pad. FIG. 7 depicts the triple relation of the wafer and the polishing pad of FIG. 6. The relation between the polishing pad 602 and the wafer 604 in the CMP machine is polish 605. This then clearly describes the “polishing pad-polish-wafer” relation. When processing a patent document, a machine can clearly understand the components mentioned in a claim, the relation among the components, and the relevant attributes of the components with the support of the domain-specific thesaurus.

Semantic/Syntactic Annotation

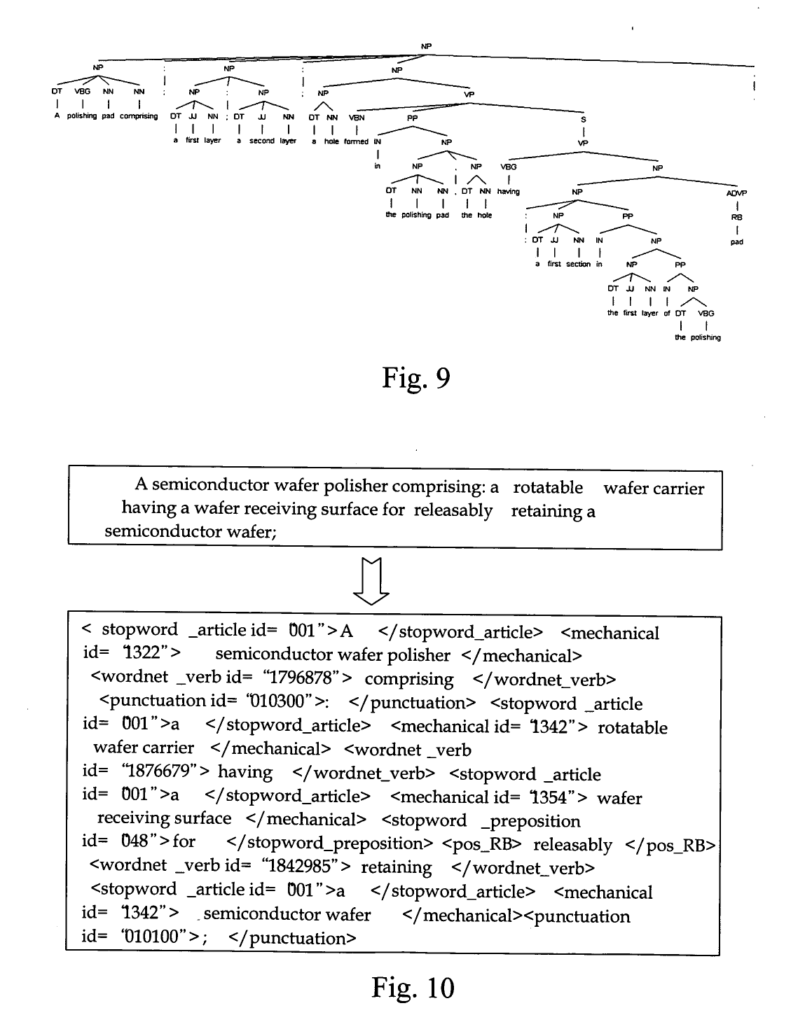

With reference to FIG. 2, we describe the semantic/syntactic annotation (step 212) as follows. In order for machines to be able to process patent documents, the computer has to first analyze the semantics of domain-specific terms in the patent documents and the syntactic information of each word (e.g. the grammatical class of each word) for the convenience of extracting the patent content structure. FIG. 8 depicts a flowchart for semantic/syntactic annotation. In the process of semantic/syntactic annotation, one first divides the sentence in a claim into single words and performs part-of-speech (POS) semantic annotation. In this embodiment, we use the JavaNLP parser developed by Stanford University to annotate the grammatical class of each word. The parser automatically determines the structure of each input sentence and parses it into a phrase structure. Using probability and statistics, each word in the phrases is provided with a specific possible grammatical class. FIG. 9 depicts an example parsing tree generated by the JavaNLP parser. FIG. 9 gives the grammatical class parsing tree analyzed by the JavaNLP parser for: “A polishing pad comprising: a first layer; a second layer; a hole formed in the polishing pad, the hole having: a first section in the first layer of the polishing pad”.

The disclosed system divides the semantic annotation into four parts:
1. Domain terminology annotation: domain-specific terms in a claim are tagged, achieved using a Domain Thesaurus Tagger. With the support of the domain-specific thesaurus, one can obtain the semantics of the domain-specific terms by comparing the annotation code with the domain-specific thesaurus.
2. Stop word annotation: stop words, such as “the” and “a” in a claim are tagged, achieved using a Stop Word Tagger.
3. Normal term annotation: verbs of normal description in a claim are tagged, achieved using a WordNet Tagger. With the support of the WordNet, one is able to obtain the semantics of the tagged verbs.
4. Punctuation annotation: punctuation in a claim is tagged, achieved using a Punctuation Tagger. FIG. 10 shows an example of semantic/syntactic annotation, where the result of the semantic/syntactic annotation for a particular claim is illustrated.

In the following, we describe how to use the regular expression to extract the semantic structure (steps 214, 216 in FIG. 2). Since the claim defines the scope of the patent contents and the largest privilege of the invention, it is therefore of great value to deeply understand the true contents of a claim. Since there are a few licit ways to compose a claim, it is very suitable for computers to extract its semantic contents. Because claims play a crucial role in legal issues, the drafting style of claims changes with the rulings of the courts. Moreover, because the wording in claims is less common and their grammatical rules are different from normal writing, the claims are difficult to read. This makes it more difficult for computers to parse the claims. In the following, we describe how to use regular expressions to extract the semantic structure of a claim.

Regular expressions are templates or patterns of text strings. Each of the templates consists of a few letters and some meta-characters with special meanings for extracting or describing text strings compliant with the template. Simply speaking, a regular expression is a language for defining language.

In 1956, the mathematician Stephen Kleene constructed a set of mathematical symbolic systems—the regular sets. Very quickly, they were adopted in scanner and lexical analyses of the compliers in computer sciences. Regular expressions derive from the automation theory and the regular language theory. They are defined by sets of corresponding text strings. Such a set is called “the language generated by regular expressions” and can be symbolically expressed as L(r).

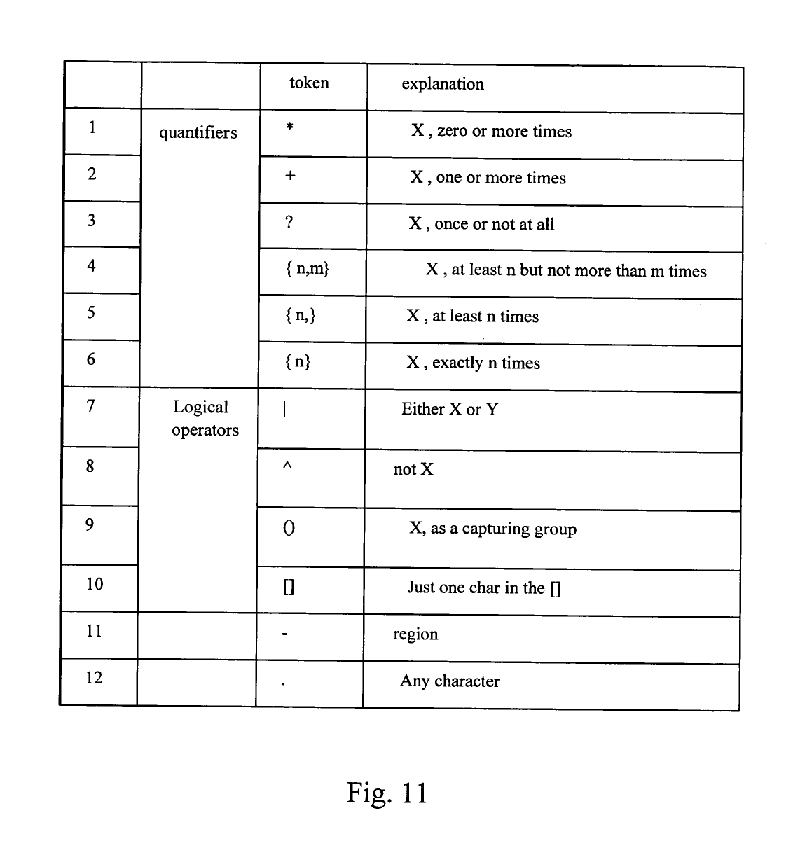

FIG. 11 depicts the meta-character function of a regular expression. The operation precedence from highest to lowest is *, >, and, >, or.

For example:
L(a|b*)={a, ε,b,bb,bbb,bbbb, . . .}
L((a|b)*)={ε,a,b,aa,ab,ba,bb . . . }

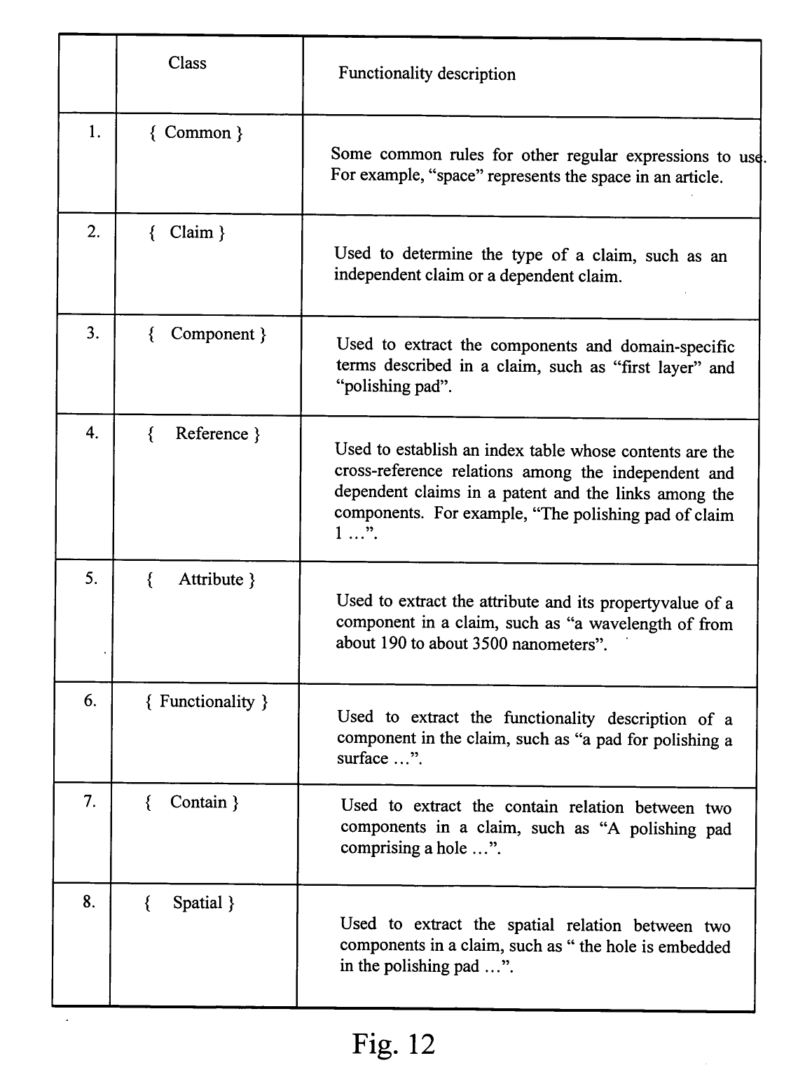

FIG. 12 depicts eight types of regular expressions for extracting the semantic structure of claims. These eight types of regular expressions are defined in the invention according to the ways of drafting claims.
L(a|b*)={a, ε,b,bb,bbb,bbbb . . .}
L((a|b)*)={ε,a,b,aa,ab,ba,bb . . .}

1. The Common type:

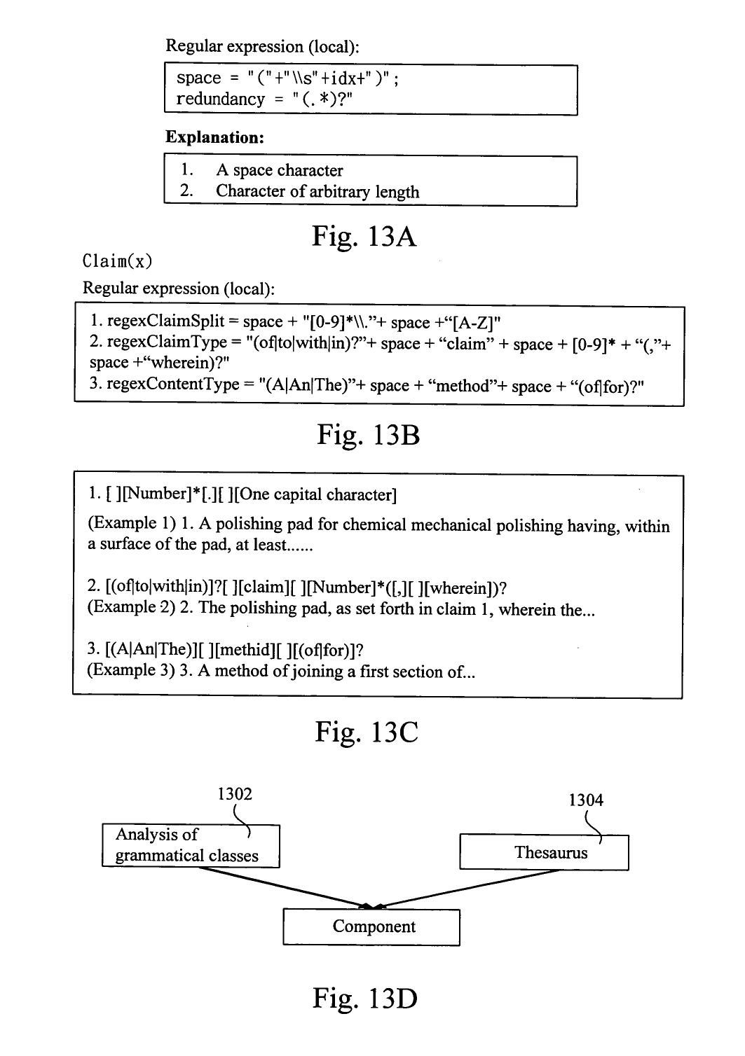

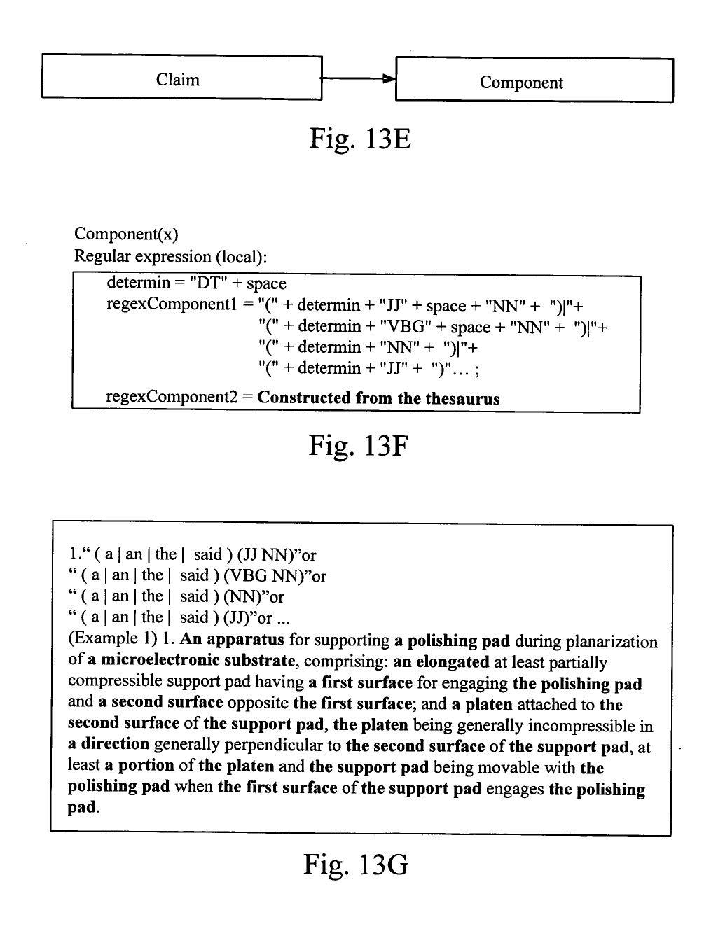

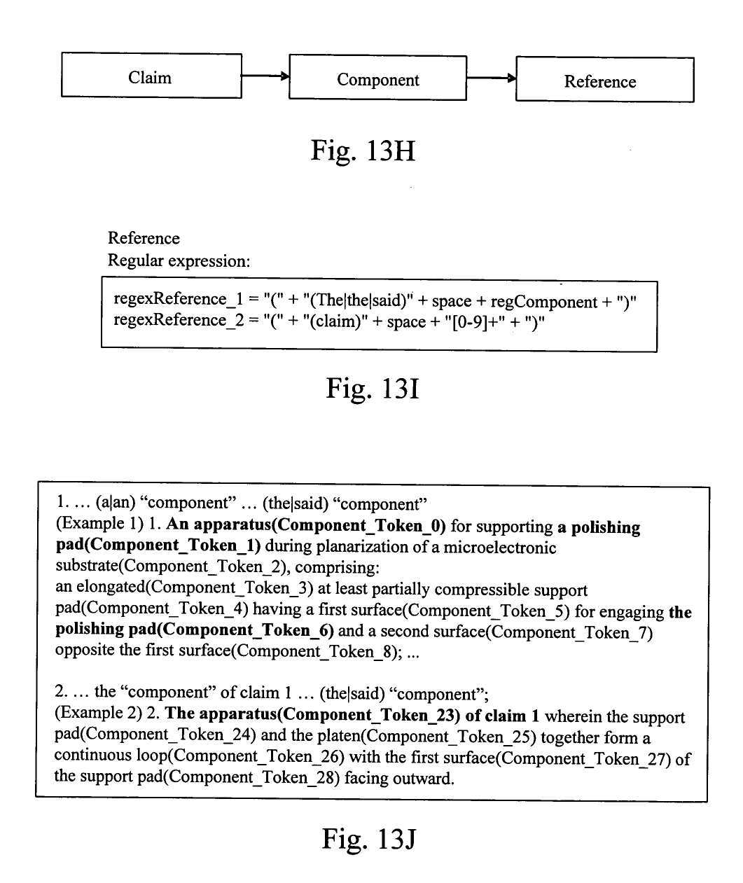

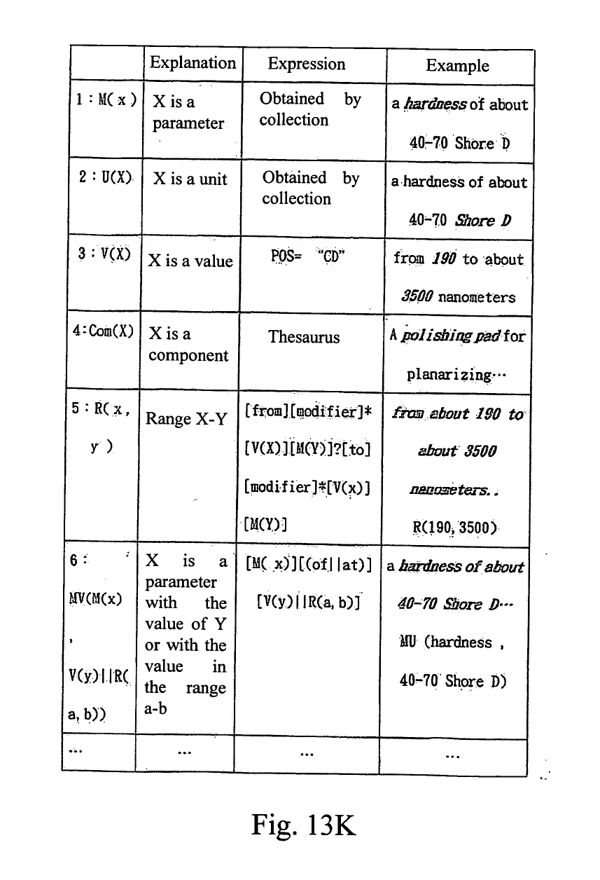

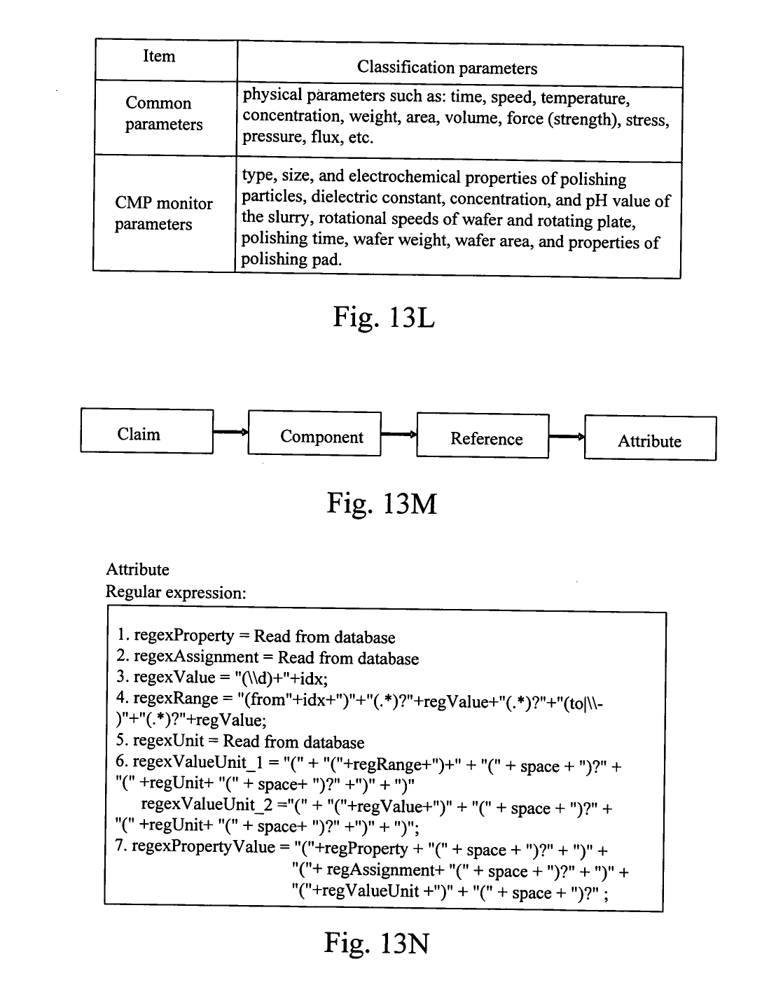

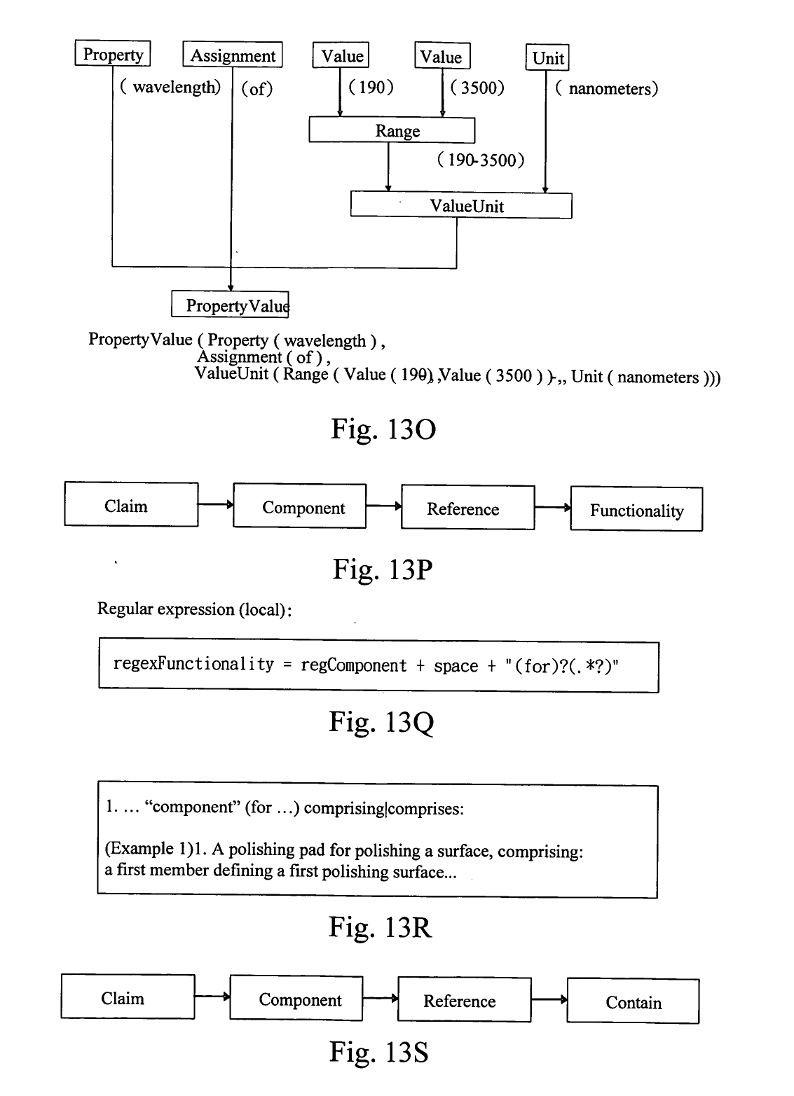

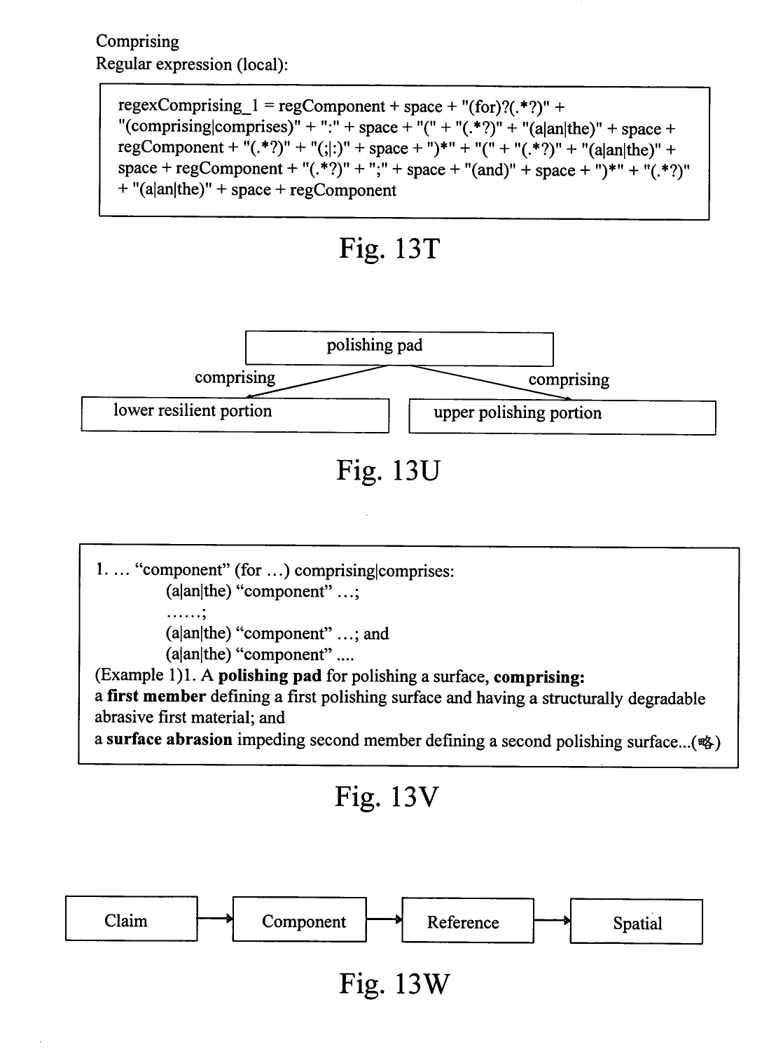

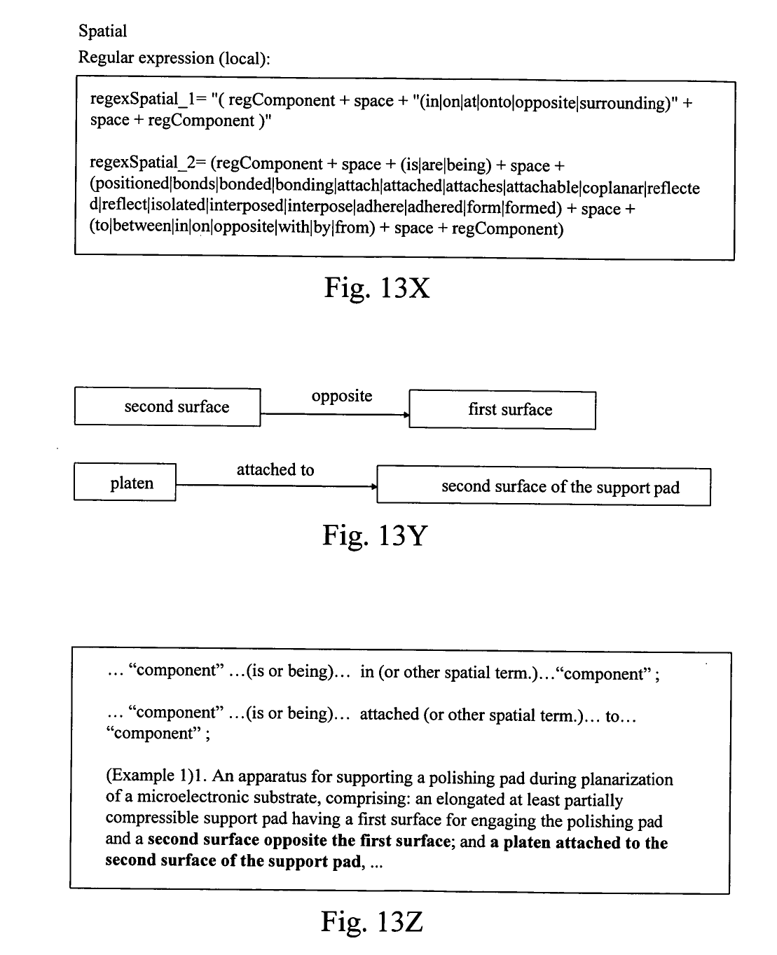

The primary purpose of this type is to set some basic and commonly used regular expressions for other types of regular expressions to use. FIG. 13A shows this type of regular expression and its explanation.

2. The Claim type:

The primary purpose of this type is to identify the claims in a patent document and automatically divide them into individual ones. Afterwards, each claim is determined to be independent or dependent, and determined to describe a device/mechanical structure, a method/procedure, or some other type. FIG. 13B shows this type of regular expression. In a patent document, the claims usually follow a fixed way of writing and have the same preamble. FIG. 13C depicts some fixed ways of writing and a few examples of preambles. For example, Example 1 is claim 1 of U.S. Pat. No. 6,544,104. The preamble of each claim is just like this one. Therefore, it may be used to determine the beginning of a claim. Example 2 shows that a normal dependent claim may have such keywords. They can thus be used to determine whether a claim is independent or dependent. Example 3 is claim 1 of U.S. Pat. No. 6,569,004. It shows that such keywords exist in a general claim for the method type of invention. Therefore, they can be used to determine the type of the claim contents. In this embodiment, we only consider the structure type of claims.

3. The Component type:

The primary purpose of this type is to extract the components described in a claim. FIG. 13D shows possible references for the component extraction. There are two ways to extract the components. One is to employ the word grammatical class analysis (step 1302), determining whether the word or phrase refers to a device. The other is to employ a domain-specific thesaurus (step 1304). Each term in the thesaurus is a device. FIG. 13E shows the execution order of the regular expressions in the Component type.

FIG. 13F shows the regular expression of component(x). In the claim drafting styles, one can find that most devices have a fixed attribute by analyzing the syntactic information and often follow an article. In particular, the article “said” is a specific writing style of patent documents. The invention can evaluate the coverage rate and accuracy of using the word grammatical class to extract the components. FIG. 13G gives an example of finding the components in U.S. Pat. No. 6,273,800. Example 1 is claim 1 of U.S. Pat. No. 6,273,800. Using the word grammatical class combinations defined in regexComponent1, one can find components shown in FIG. 13G.

4. The Reference type:

The primary purpose of this type is to establish reference links among components and links between independent claims and dependent claims. According to the legal format of claim drafting, a component is always preceded by an article “a” or “an” when it is mentioned in the claims for the first time, and it is preceded by “the” or “said” when it is referred to afterwards for a clear distinction. During the execution of the Component type of regular expression, all components are extracted without establishing the references among the components. The Reference type of regular expression is used to automatically link the referred component to the first described component. This can reduce the complexity of information for the convenience of human analysis and reading.

In practice, the system searches for components that are described twice or more. If such a component appears in an independent claim, the system finds where the component is first described in the same claim. If the component appears in a dependent claim, the system first use the second regular expression to determine which independent claim the current dependent claim refers to. Once found, the same method is used to establish a reference index. FIG. 13H shows the execution order of the regular expressions in the Reference type. FIG. 13I shows the regular expressions of the Reference type.

Example 1 is claim 1 in U.S. Pat. No. 6,273,800. The phrase “polishing pad (Component_Token_{—}1)” is a polishing pad device appearing for the first time in the claim, while the phrase “polishing pad (Component_Token_{—}6)” is the polishing pad device appearing for the second time in the claim. The disclosed system automatically establishes a link table, explicitly stating that “Component_token_{—}6” is the same as “Component_token_{—}1”. Although in Example 2 “apparatus (Component_Token_{—}23)” is described in claim 2, the system still uses the regular expression for automatic determination, knowing that “Component_token_23” is actually “Component_token_{—}1” in claim 1.

FIG. 13J depicts an example of finding components in U.S. Pat. No. 6,273,800.

5. The Attribute type:

The primary purpose of this type is to extract the attribute descriptions of the component in a claim. There are seven sub-types: property, assignment, value, range, unit, unitvalue, and propertyvalue.

The property refers to the one that the system is going to extract. FIG. 13K depicts a definition example of this regular expression. FIG. 13L depicts a parameter example of CMP. Since there are many parameters in CMP, the Attribute analysis of the component in this embodiment emphasizes various process monitoring parameters in CMP along with the contact types between the two polishing surfaces and the fluid conditions of the slurry. This helps the parameter similarity comparisons for CMP patents in the future.

The assignment refers to the relation between the property and the propertyvalue. Such a relation may be “greater than”, “equal to”, or “less than”. The propertyvalue may be an integer, real number, or ordinal words such as “one”, “two”, and “three”. The range is used to define a numerical range. The unit refers to the unit of the property, currently collected and established by human beings in the database. The unitvalue integrates the value, the range, and the unit to express a particular value or a range of value along with its unit. Finally, the propertyvalue integrates the property, the assignment, and the unitvalue to indicate the relation between a particular property in a certain unit and its value. Using the triple relation, it can be defined as PropertyValue (Property(x),Assignment(y),Valueunit(z)).

FIG. 13M shows the execution order of the regular expressions in the Attribute type. FIG. 13N gives an example of the regular expression in the Attribute type. As shown in the drawings, there are seven entries in the Attribute type. Using the regular expression, the system can recognize that “wavelength” is the property, “of” is the assignment, “190” and “350” are values and thus the range, “nanometer” is the unit, which combines with the range to form the unitvalue, and finally the above information is integrated to give the propertyvalue. After the information retrieval using the regular expression, the system can extract a property from claim 19 of U.S. Pat. No. 6,454,634, and obtain the following expression: PropertyValue(Property(wavelength),Assignment(of),ValueUnit(Range(Value(190),-, Value(3500)),-,Unit(nanometers))).

FIG. 13O depicts the expression obtained from claim 19 of U.S. Pat. No. 6,454,634.

6. The Functionality type:

The primary purpose of this type is to extract the functionality description of the component in a claim. In claims, a component is often provided with functionality descriptions in order to clearly define the functions of the component in the invention and the legal scope of the component. FIG. 13P depicts the execution order of the regular expressions in the Functionality type. FIG. 13Q depicts an example of the regular expression in the Functionality type.

Example 1 is claim 1 in U.S. Pat. No. 6,517,425. The disclosed system can extract the polishing pad according to the regular expression, along with a functionality description “polishing a surface”. FIG. 13R depicts a schematic view of the polishing pad extracted from the regular expression.

7. The Contain type:

The primary purpose of this type is to extract a part-of relation between two components in the claims and to use such a relation to relate the two components, forming a triple relation. The triple relation form is defined as: Contain (Component(x), ContainVerb(m), Component (y)). There are five commonly used Contain relations in claims: “comprising”, “consisting of”, “essentially consisting of”, “including”, and “having”.

FIG. 13S depicts the execution order or the regular expression in the Contain type. FIG. 13T depicts an example of the regular expression in the Contain type. Example 1 is claim 1 in U.S. Pat. No. 6,517,425. The disclosed system can extract two triple relations according to the regular expression:
1) Contain (polishing pad, comprising, lower resilient portion)
2) Contain (polishing pad, comprising, upper polishing portion)
1)FIG. 13U is a schematic view of the Contain relation. FIG. 13V is a schematic view of the polishing pad extracted according to the regular expression.

8. The Spatial type:

The primary purpose of this type is to extract the spatial relation between two components in a claim and to use such a relation to relate the two components, forming a triple relation. The form of the triple relation is defined as: Spatial (Component(x), SpatialTerm(m), Component (y)). Terms expressing spatial relations include prepositions and verbs. Examples of prepositions are: “in”, “on”, “at”, “onto”, “opposite”, and “surrounding”. Examples of verbs are: “position”, “bond”, “attach”, “coplanar”, “reflect”, “isolate”, “interpose”, “adhere”, and “form”.

FIG. 13W depicts the execution order of the regular expression of the Spatial type. FIG. 13X depicts the regular expression of the Spatial relation. Example 1 is claim 1 in U.S. Pat. 6,273,800. The disclosed system can extract two triple relations according to the regular expression:

1) Spatial (second surface, opposite, first surface)

2) Spatial (platen, attached, second surface of the support pad)

FIG. 13Y is a schematic view of the Spatial relation. FIG. 13Z is a schematic view of the polishing pad extracted according to the regular expression.

1) After the information retrieval of the above-mentioned eight types of regular expressions, the semi-structured data in a claim can be converted by the disclosed system into structured information. It can be further presented in the XML and OWL formats.

In the following, a complete example is provided to discuss the claim contents retrieval process.

Example of extracting claim contents:

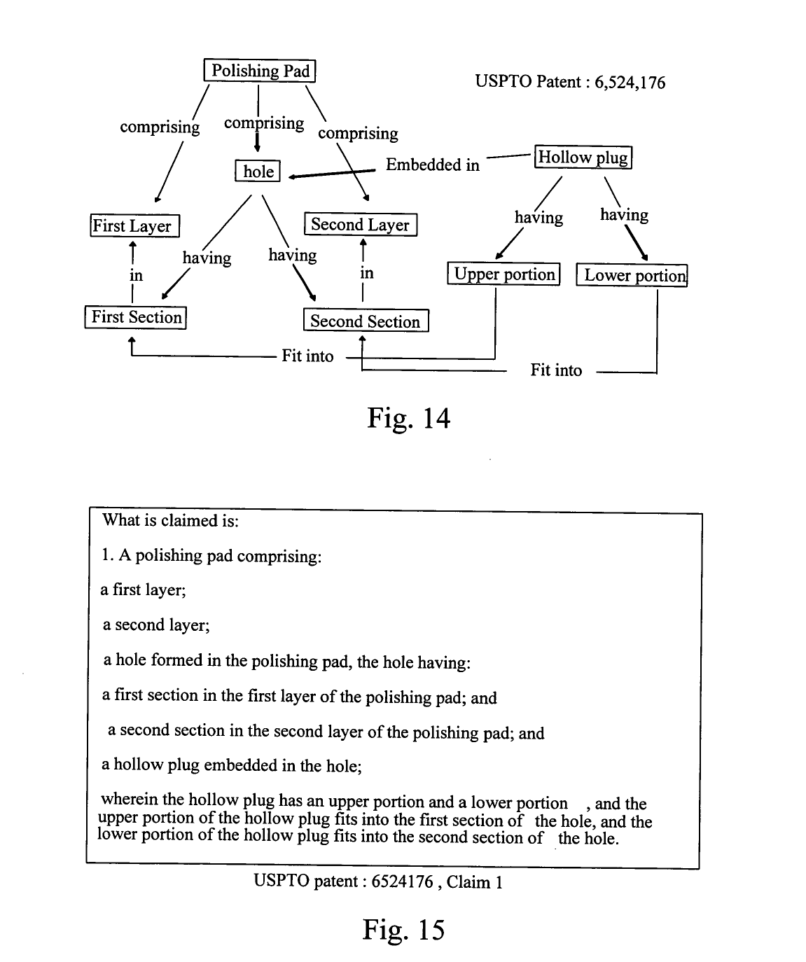

After the semantic/syntactic annotation, each word in a claim is associated with the corresponding semantic/syntactic information. The claim structure extraction is illustrated in steps 218, 220, and 222 of FIG. 2. FIG. 14 depicts an example of the structure of the component in the claim. To extract the structure in a claim means that the regular expression is used to automatically extract all the components, the relations among the components, and the attributes of the components from the claim and to present the structure in a graphical way (FIG. 14). Such a structure graph in this embodiment is called a semantic graph. Claims are either independent or dependent. The disclosed system also automatically performs reference links for these two types of claims in order to obtain the dependence relations. A single semantic graph is constituted from an independent claim and its dependent claim. If a patent document has several independent claims, the disclosed system automatically establishes multiple semantic graphs. Since a complete semantic graph is immense, this embodiment only uses the first independent claim in U.S. Pat. No. 6,524,176 as an example to explain the invention.

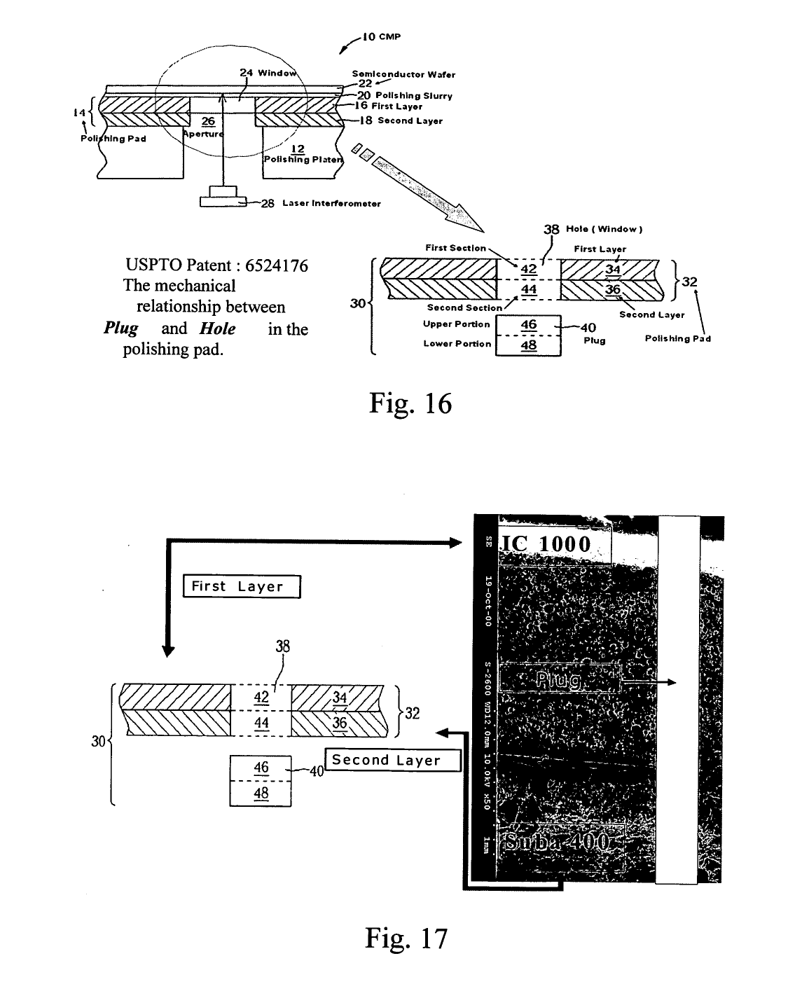

FIG. 15 shows the first claim in U.S. Pat. No. 6,524,176. This claim is an independent claim. It describes the structure of a polishing pad in CMP. The polishing pad comprises three elements: a first layer, a second layer, and a hole. The hole further has a first section and a second section. A plug is embedded in the hole. The plug includes an upper portion and a lower portion. The upper portion of the plug is fitted into the first section of the hole, while the lower portion of the plug is fitted into the second section of the hole. FIG. 16 provides an example showing the structure of the plug and the hole. FIG. 17 shows the two layers of the polishing pad and an actual microscopic picture in comparison.

Using the regular expression, the computer can parse a claim step by step. First, it extracts components in a claim (achieved by the Component type in the regular expression), such as the polishing pad, the hole, the first layer, the second layer, the first section, the second section, the plug, the upper portion, and the lower portion. Afterwards, the disclosed system establishes the reference relation among the components (achieved using the regular expression in the Reference type). In the drafting of claims, an article “a” or “an” is used in front of a component when it is described for the first time. In the latter description, whether in the same claim or not, an article “the” or “said” has to be used in front of the component in order to clearly state which component it is referring to and to avoid any ambiguity. After establishing the reference relation, the disclosed system extracts the attributes along with their values of each component described in the claim (achieved using the regular expression in the Attribute type). The attribute includes the property, the propertyvalue, and the unit. If there is any functionality description for a component in the claim, the disclosed system also extracts and saves it (achieved using the regular expression in the Functionality type). Finally, the disclosed system extracts and automatically establishes the relations among the components. The relations in this retrieval include terms of spatial relations (achieved using the regular expression in the Spatial type), such as “embedded” and “fitted” in the examples, and terms of contain relations (achieved using the regular expression in the Contain type), such as “comprise” and “consist of” in the examples.

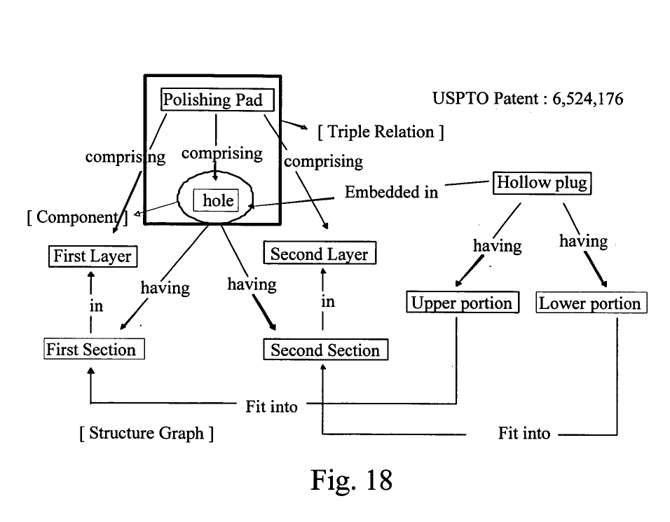

In the semantic graph of a claim, a pair of components is called a triple relation. The triple relation takes the two components and their relation as its basic units. FIG. 18 depicts a semantic graph of the claim. From the drawing, it is seen that the semantic graph consists of many triple relations.

The disclosed system automatically converts the information extracted using regular expressions into a machine-readable file in the XML and OWL formats (step 218 in FIG. 2).

Since the disclosed system includes a domain-specific thesaurus and converts its hierarchical structure into substantial knowledge, each component can be recognized as a particular class or instance if the component has an annotation at the stage of semantic annotation. For those components that do not have annotation in the domain-specific thesaurus, the system puts them into the Component class. Moreover, the relations between any two components follow specific rules.

Graphical Presentation of the Semantic Structure of a Patent Document

After the disclosed system extracts the semantic information with the help of the regular expressions and expresses it in the OWL format, such a machine-readable file is still difficult for human beings to read and understand. FIG. 18 depicts an example of the component structure for a claim. Using the regular expressions and the definitions of tokens, the computer can extract the structure of component relations described using terms of spatial relation nature in the claim, along with the attributes of the components. The component structure graph of a claim is called a structure graph. The relation between a pair of components is called a triple relation. The triple relation takes the components as the units. Each component is recorded with the attributes mentioned in the claim. Therefore, once the OWL file is converted into a graphical representation, the user can readily know what the claim content is from the graph. With the help of a graphical interface, the user can contrast the semantic graph with the claim text to quickly grasp the key information of the patent. When the user finds that there is any mistake in the regular expression, he or she can use the graphical interface to directly update the semantic graph. The disclosed system modifies the OWL file accordingly and saves it to the database.

The invention has at least the following advantages. Each embodiment has one or more of the advantages. The disclosed patent document content construction method can perform automatic analysis and structure retrieval on claims of a patent document. The disclosed patent document content construction method helps us extract and index knowledge for providing more accurate professional information.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A patent document content construction method, comprising the steps of:
establishing a domain-specific thesaurus containing a plurality of domain-specific terms that form a hierarchical structure;
performing annotation on a claim of the patent to identify domain-specific terms, stop words, general words, and punctuation in the claim; and
using the thesaurus to establish a structural relation for the claim, the structural relation including domain-specific terms, general terms, and triple relations of the domain-specific terms and the general terms.

2. The method of claim 1, further comprising the step of classifying domain-specific terms of the same class into one level in the hierarchical structure of the domain-specific thesaurus.

3. The method of claim 1, wherein the step of part-of-speech (POS) syntactic annotation is performed on the claim before the semantic/syntactic annotation.

4. The method of claim 1, further comprising the step of comparing a term appearing in the claim with the domain-specific terms in the domain-specific thesaurus to determine the content of the term in the claim in the step of performing the semantic/syntactic annotation.

5. The method of claim 1, wherein the stop words include “a” and “the”.

6. The method of claim 1, wherein the claim is an independent claim.

7. The method of claim 1, wherein the claim is a dependent claim and the method performs the step of semantic/syntactic annotation on the dependent claim and the associated independent claim and establishes the structural relation.

8. The method of claim 1, further comprising the step of using a structure graph to show the structural relation of the claim.

9. The method of claim 8, further comprising using a regular expression and the definitions of a plurality of tokens to determine the structure graph.

10. The method of claim 1, further comprising the step of using a regular expression to parse the claim.

11. The method of claim 10, wherein the regular expression includes identifying a component of the claim.

12. The method of claim 10, wherein the regular expression includes identifying a reference link between two components in the claim.

13. The method of claim 10, wherein the regular expression includes identifying attributes of a component in the claim.

14. The method of claim 10, wherein the regular expression includes identifying a functionality description of a component in the claim.

15. The method of claim 10, wherein the regular expression includes identifying whether a part-of relation exists between two components in the claim.

16. The method of claim 10, wherein the regular expression includes identifying whether a spatial relation exists between two components in the claim.

17. A patent document content construction method, comprising the steps of:
performing semantic/syntactic annotation on a claim of the patent to identify domain-specific terms, stop words, general words, and punctuation in the claim; and
using a domain-specific thesaurus to establish a structural relation for the claim, the structural relation including domain-specific terms, general terms, and triple relations of the domain-specific terms and the general terms.

18. The method of claim 17, wherein the domain-specific thesaurus contains a plurality of domain-specific terms in a particular domain, and the domain-specific terms form a hierarchical structure.

19. The method of claim 17, further comprising the step of comparing a term appearing in the claim with the domain-specific terms in the domain-specific thesaurus to determine the content of the term in the claim in the step of performing the semantic/syntactic annotation.

20. The method of claim 17, further comprising the step of using a structure graph to show the structural relation of the claim.
